(19) United States
(12) Patent Application Publication
(10) Pub. No.: US 2025/0227668 A1
(43) Pub. Date: Jul. 10, 2025

(54) UPLINK TRANSMISSION METHOD AND APPARATUS, AND STORAGE MEDIUM

(71) Applicant: Beijing Xiaomi Mobile Software Co., Ltd., Beijing (CN)

(72) Inventor: Qun ZHAO, Beijing (CN)

(21) Appl. No.: 18/850,505

(22) PCT Filed: Mar. 30, 2022
(86) PCT No.: PCT/CN2022/084195

§ 371 Date: Sep. 24, 2024

(51) Int. Cl. H04W 72/0446

(52) U.S. Cl. CPC H04W 72/0446

(57) ABSTRACT

An uplink transmission method is performed by a terminal, and includes: receiving a configuration signaling, for configuring an uplink subband in a designated time unit, transmitted by a base station, wherein the designated time unit is adjacent to an uplink resource in time domain and after an uplink time unit, and a transmission direction of the designated time unit is not designated as an uplink direction; and determining, based on the configuration signaling, the uplink subband for uplink transmission in the designated time unit.

### CROSS REFERENCE TO RELATED APPLICATIONS

This application is a U.S. National Phase of International Application No. PCT/CN2022/084195, filed on Mar. 30, 2022, the entire contents of which are incorporated herein by reference.

### TECHNICAL FIELD

The present disclosure relates to the field of communication technologies, and in particular to uplink transmission methods and apparatuses, and storage mediums.

### BACKGROUND

A full-duplex scheme is researched in the Release-18 (Rel-18) duplex enhancement project, specifically, a network device can simultaneously perform data reception and data transmission in a single slot.

Currently, the 3rd generation partnership project (3GPP) has determined that Rel-18 duplex enhancement for full duplex is only for a next generation node B (gNB), and a terminal (e.g., a user equipment, UE) still only supports half duplex. The gNB can configure an uplink (UL) subband for uplink data transmission in a downLink (DL) slot for a cross division duplex (xDD) terminal, and schedule the uplink data transmission of the terminal in the time-frequency range of the UL subband.

For the terminal, when the terminal switches from a state in which downlink data reception is performed to a state in which uplink data transmission is performed, a certain amount of time is required for switching the radio frequency (RF) device of the terminal. Moreover, a guard period is required to avoid interference to uplink transmissions caused by maintaining synchronization on the network side. There is no clear solution on how to ensure sufficient switching time of downlink/uplink on the terminal side in a full-duplex (e.g., xDD) scenario and how to protect the uplink transmission from interruption from the downlink.

### SUMMARY

According to a first aspect of the embodiments of the present disclosure, there is provided an uplink transmission method, performed by a terminal, and including:

receiving a configuration signaling, for configuring an uplink subband in a designated time unit, transmitted by a base station, where the designated time unit is a time unit which is adjacent to an uplink resource in time domain and after an uplink time unit, and of which a transmission direction is not designated as an uplink direction; and

determining, based on the configuration signaling, the uplink subband for uplink transmission in the designated time unit.

According to a second aspect of the embodiments of the present disclosure, there is provided an uplink transmission method, performed by a terminal, and including:

receiving a scheduling signaling transmitted by a base station, where the scheduling signaling is configured to schedule a resource position for uplink transmission in a downlink time unit; and

performing the uplink transmission at the resource position scheduled by the scheduling signaling.

According to a third aspect of the embodiments of the present disclosure, there is provided an uplink transmission method, performed by a base station, and including:

transmitting a configuration signaling for configuring an uplink subband in a designated time unit to a terminal, where the designated time unit is a time unit which is adjacent to an uplink resource in time domain and after an uplink time unit, and of which a transmission direction is not designated as an uplink direction, and the uplink subband is for the terminal to perform uplink transmission.

According to a fourth aspect of the embodiments of the present disclosure, there is provided an uplink transmission method, performed by a base station, and including:

transmitting a scheduling signaling to a terminal, where the scheduling signaling is configured to schedule a resource position for uplink transmission in a downlink time unit.

According to a fifth aspect of embodiments of the present disclosure, there is provided a non-transitory computer-readable storage medium, storing computer programs thereon, where the computer programs, when executed by a processor, cause the processor to perform any one of the uplink transmission methods of the terminal side.

According to a sixth aspect of embodiments of the present disclosure, there is provided a non-transitory computer-readable storage medium, storing computer programs thereon, where the computer programs, when executed by a processor, cause the processor to perform any one of the uplink transmission methods of the base station side.

According to a seventh aspect of the embodiments of the present disclosure, there is provided an uplink transmission device including: a processor; and a memory storing instructions executable by the processor; where the instructions, when executed by the processor, cause the processor to perform any one of the uplink transmission methods of the terminal side.

According to an eighth aspect of the embodiments of the present disclosure, there is provided an uplink transmission device including: a processor; and a memory storing instructions executable by the processor; where the instructions, when executed by the processor, cause the processor to perform any one of the uplink transmission methods of the base station side.

### BRIEF DESCRIPTION OF THE DRAWINGS

The accompanying drawings herein, which are incorporated in and constitute a part of the present description, illustrate examples consistent with the present disclosure and serve to explain the principles of the present disclosure together with the description.

FIG. 1A is a schematic diagram illustrating a scenario in which a base station is synchronized with a terminal according to an embodiment of the present disclosure.

FIG. 1B is a schematic diagram illustrating a scenario of switching from downlink reception to uplink transmission according to an embodiment of the present disclosure.

FIG. 2 is a flowchart illustrating an uplink transmission method according to an embodiment of the present disclosure.

FIG. 3 is a flowchart illustrating an uplink transmission method according to another embodiment of the present disclosure.

FIG. 4 is a flowchart illustrating an uplink transmission method according to yet another embodiment of the present disclosure.

FIG. 5 is a flowchart illustrating an uplink transmission method according to still another embodiment of the present disclosure.

FIGS. 6A to 6C are schematic diagrams illustrating a frequency domain resource for downlink transmission and uplink transmission according to an embodiment of the present disclosure.

FIGS. 7A to 7B are schematic diagrams illustrating a scenario of configuration for an uplink subband according to an embodiment of the present disclosure.

FIG. 8 is a schematic diagram illustrating a scenario for determining a resource position for an uplink transmission based on a scheduling signaling according to an embodiment of the present disclosure.

FIG. 9 is a block diagram illustrating an uplink transmission apparatus according to an embodiment of the present disclosure.

FIG. 10 is a block diagram illustrating an uplink transmission apparatus according to another embodiment of the present disclosure.

FIG. 11 is a block diagram illustrating an uplink transmission apparatus according to yet another embodiment of the present disclosure.

FIG. 12 is a block diagram illustrating an uplink transmission apparatus according to still another embodiment of the present disclosure.

FIG. 13 is a schematic structural diagram illustrating an uplink transmission device according to an embodiment of the present disclosure.

FIG. 14 is a schematic structural diagram illustrating an uplink transmission device according to another embodiment of the present disclosure.

### DETAILED DESCRIPTION OF THE EMBODIMENTS

Examples will be described in detail herein, with the illustrations thereof represented in the drawings. Where the following description relates to the drawings, unless otherwise indicated, the same numerals in different drawings represent the same or similar elements. Implementations described in the following examples do not represent all implementations consistent with the present disclosure. On the contrary, they are examples of an apparatus and a method consistent with some aspects of the present disclosure described in detail in the appended claims.

The terminology used herein is for the purpose of describing particular embodiments only and is not intended to be limiting of the present disclosure. As used herein, the singular forms “a”, “said” and “the” are intended to include the plural forms as well, unless the context clearly indicates otherwise. It will also be understood that as used herein, the term “and/or” is and includes any or all combinations of one or more of the associated listed items.

It will be understood that while terms such as “first”, “second”, “third”, etc. may be used to describe to describe various information, such information should not be limited to these terms. These terms are used only to distinguish the same type of information from each other. For example, without departing from the scope of the present disclosure, a first information may also be referred to as a second information, and similarly, a second information may also be referred to as a first information. Depending on the context, as used herein, the wording “if” may be interpreted as “while . . . ” or “when . . . ” or “in response to a determination”.

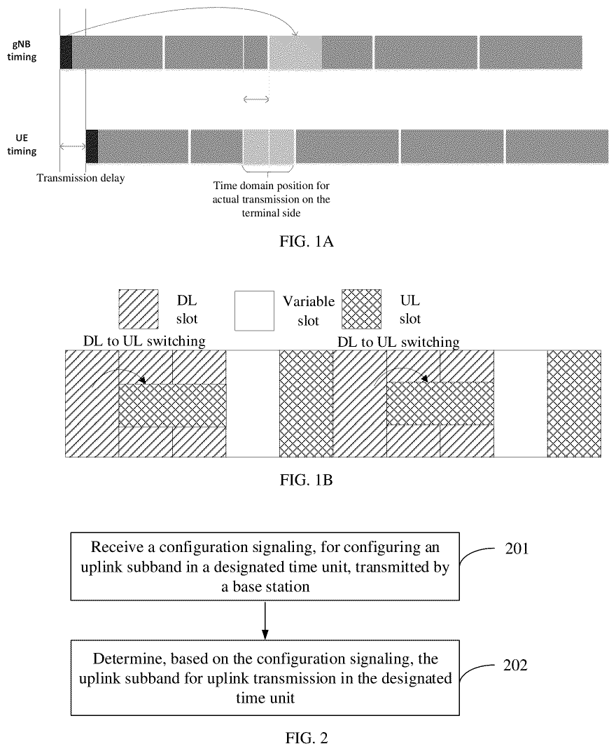

Referring to FIG. 1A, it is considered that there is a transmission delay for the downlink transmission from the base station to the terminal, if it is necessary to maintain synchronization between the terminal side and the network side, the terminal needs to perform the uplink transmission in advance, so as to ensure that the signal or signaling of the uplink transmission reaches the base station at the desired time point of the base station.

In a new radio (NR) system, the base station can indicate the current time division duplex (TDD) uplink (UL) and downlink (DL) configuration of the terminal in a semi-static or dynamic manner.

The semi-static TDD UL-DL configuration is configured via a system information block (SIB) and/or a radio resource control (RRC) signaling. The base station configures the uplink and downlink structure at the cell level through a high-level signaling. During the configuration period of the base station, the base station configures the position and number of downlink slots, downlink symbols, flexible slots (variable slots), flexible symbols, uplink slots, and uplink symbols.

The uplink and downlink structure of one or more slots is dynamically indicated by a slot format indication (SFI) carried by downlink control information (DCI) format 2_0. The slot format that can be indicated by the base station has been defined in TS38.213.

The problem of switching between uplink and downlink slots in the TDD band is solved in the current protocol by configuring or indicating flexible symbols between DL/UL symbols. Specifically, the terminal does not expect to transmit or receive data on the flexible symbol until the terminal receives an explicit indication from the base station. The base station ensures, through scheduling, that the terminal has sufficient switching time of downlink/uplink as well as protects the uplink transmission from interruption from the downlink.

However, the TDD UL-DL configuration is to be used in the whole working bandwidth regardless of the semi-static configuration mode or the dynamic indication mode. That is, when there are both an uplink resource and a downlink resource in a slot, the current scheme can not solve the related problem faced by a xDD terminal.

Referring to FIG. 1B, from the terminal point of view, if the UL subband can be configured in any DL slot, the base station needs to configure or ensure a sufficient guard period between each DL symbol and the UL subband. Since the terminal does not expect to receive or transmit data during the guard period, the additional guard period reduces the resource efficiency of the network.

In other words, the xDD terminal, when transmitting uplink data on the DL slot, has the following technical problems:

a certain amount of switching time is required for the terminal to switch from downlink reception to uplink transmission;

in order to achieve network side synchronization, the guard period between DL and UL needs to be reasonably configured or indicated to avoid interruption from downlink transmission to uplink transmission;

the negative impact of additional guard period on system performance needs to be reduced.

To overcome the problem in the related art, the embodiments of the present disclosure provide uplink transmission methods. The uplink transmission method provided by the present disclosure is described below from the terminal side.

An embodiment of the present disclosure provides an uplink transmission method, which can be performed by a terminal. FIG. 2 is a flowchart illustrating the uplink transmission method according to the embodiment of the present disclosure. As shown in FIG. 2, the method can include the following steps 201 to 202.

At step 201, a configuration signaling, for configuring an uplink subband in a designated time unit, transmitted by a base station is received.

In this embodiment, the designated time unit is a time unit which is adjacent to an uplink resource in time domain and after an uplink time unit, and of which a transmission direction is not designated as an uplink direction. The base station may explicitly configure the uplink subband via a signaling, and the configuration signaling may be a radio resource control (RRC) signaling, a physical layer signaling, a system message, etc., which is not limited by the present disclosure.

In a possible implementation, the designated time unit includes a downlink slot, or the designated time unit includes a downlink symbol and a slot for a variable symbol, where the variable symbol is a symbol with a variable transmission direction. Of course, the designated time unit may also include a downlink symbol.

In a possible implementation, the terminal can determine a transmission direction of each time unit based on the time division duplex uplink and downlink configuration message transmitted by the base station, so as to determine the designated time unit based on the transmission direction of each time unit.

In a possible implementation, the uplink time unit is an uplink symbol, and the designated time unit includes a slot or a plurality of consecutive slots that is adjacent to the uplink resource in the time domain and after the uplink symbol.

In a possible implementation, the uplink subband may be contiguous in the time domain, i.e., no additional DL to UL switching point is required for a terminal to switch from downlink reception to uplink transmission.

At step 202, based on the configuration signaling, the uplink subband for uplink transmission is determined in the designated time unit.

In an embodiment of the present disclosure, the terminal may determine, based on the configuration information, an uplink subband in the designated time unit, so as to perform uplink transmission on the frequency domain resource occupied by the uplink subband.

In the present disclosure, when the terminal performs the uplink transmission on the uplink subband in the designated time unit, a variable symbol in the time division duplex uplink and downlink configuration message can serve as a guard period for switching from downlink reception to uplink transmission. Therefore, the present disclosure can effectively solve the problem that the terminal needs additional switching time from downlink reception to uplink transmission, and can avoid interference from downlink transmission to uplink transmission, reduce the negative impact of the additional guard period on the system performance, and improve the feasibility and reliability of the full-duplex (e.g., cross division duplex, xDD) communication.

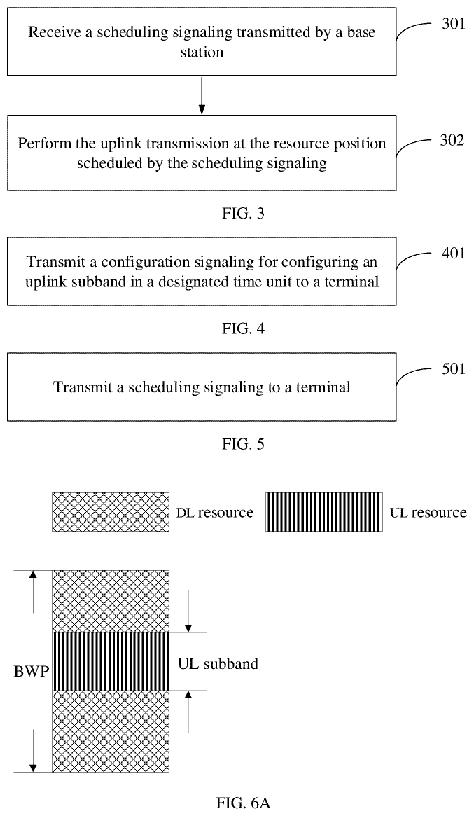

An embodiment of the present disclosure provides an uplink transmission method, which can be performed by a terminal. FIG. 3 is a flowchart illustrating the uplink transmission method according to the embodiment of the present disclosure. As shown in FIG. 3, the method can include the following steps 301 to 302.

At step 301, a scheduling signaling transmitted by a base station is received.

In this embodiment, the scheduling signaling is configured to schedule a resource position for uplink transmission in a downlink time unit. That is, the base station no longer explicitly configures the uplink subband through a signaling, but instead instructs the terminal to schedule the resource position for the uplink transmission in the downlink time unit by means of uplink scheduling.

In a possible implementation, the scheduling signaling includes downlink control information (DCI) or a radio resource control (RRC) signaling.

In a possible implementation, the downlink time unit includes a downlink slot or a downlink symbol adjacent to an uplink resource in time domain.

In a possible implementation, the terminal can determine a transmission direction of each time unit based on the time division duplex uplink and downlink configuration message transmitted by the base station, so as to determine the downlink time unit based on the transmission direction of each time unit.

At step 302, the uplink transmission is performed at the resource position scheduled by the scheduling signaling.

In the embodiments of the present disclosure, the terminal may perform the uplink transmission at the resource position scheduled by the DCI, or the terminal may perform the uplink transmission at the resource position scheduled by the RRC signaling.

It is also noted that the terminal does not expect the base station to schedule the uplink transmission in a downlink time unit that is not adjacent to the uplink resource in the time domain. Also, the terminal does not expect a guard period between the uplink subband and the downlink time unit (downlink time slot or downlink symbol).

In the embodiment, the terminal can perform the uplink transmission based at the resource position scheduled by the scheduling signaling, and a variable symbol in the time division duplex uplink and downlink configuration message can serve as a guard period for switching from downlink reception to uplink transmission. Therefore, the present disclosure can effectively solve the problem that the terminal needs additional switching time from downlink reception to uplink transmission, and can avoid interference from downlink transmission to uplink transmission, reduce the negative impact of the additional guard period on the system performance, and improve the feasibility and reliability of the full-duplex (e.g., cross division duplex, xDD) communication.

The uplink transmission method provided by the present disclosure is described below from the base station side.

An embodiment of the present disclosure provides an uplink transmission method, which can be performed by a base station. FIG. 4 is a flowchart illustrating the uplink transmission method according to the embodiment of the present disclosure. As shown in FIG. 4, the method can include the following step 401.

At step 401, a configuration signaling for configuring an uplink subband in a designated time unit is transmitted to a terminal.

In this embodiment, the designated time unit is a time unit which is adjacent to an uplink resource in time domain and after an uplink time unit, and of which a transmission direction is not designated as an uplink direction, and the uplink subband is for the terminal to perform uplink transmission. The base station may explicitly configure the uplink subband via a signaling, and the configuration signaling may be a radio resource control (RRC) signaling, a physical layer signaling, a system message, etc., which is not limited by the present disclosure.

In an embodiment, the designated time unit includes a downlink slot, or the designated time unit includes a downlink symbol and a slot for a variable symbol, where the variable symbol is a symbol with a variable transmission direction. Of course, the designated time unit may also include a downlink symbol.

In a possible implementation, the base station can transmit the time division duplex uplink and downlink configuration message to the terminal to indicate a transmission direction of each time unit, and the terminal determines the designated time unit based on the transmission direction of each time unit.

In a possible implementation, the uplink time unit is an uplink symbol, and the designated time unit includes a slot or a plurality of consecutive slots that is adjacent to the uplink resource in the time domain and after the uplink symbol.

In a possible implementation, the uplink subband may be contiguous in the time domain, such that it is ensured that no additional DL to UL switching point is required.

In this embodiment, the base station explicitly configures the uplink subband through the configuration signaling, such that the present disclosure can effectively solve the problem that the terminal needs additional switching time from downlink reception to uplink transmission, and can avoid interference from downlink transmission to uplink transmission, reduce the negative impact of the additional guard period on the system performance, and improve the feasibility and reliability of the full-duplex (e.g., cross division duplex, xDD) communication.

An embodiment of the present disclosure provides an uplink transmission method, which can be performed by a base station. FIG. 5 is a flowchart illustrating the uplink transmission method according to the embodiment of the present disclosure. As shown in FIG. 5, the method can include the following step 501.

At step 501, a scheduling signaling is transmitted to a terminal.

In this embodiment, the scheduling signaling is configured to schedule a resource position for uplink transmission in a downlink time unit. That is, the base station no longer explicitly configures the uplink subband through a signaling, but instead instructs the terminal to schedule the resource position for the uplink transmission in the downlink time unit by means of uplink scheduling.

In a possible implementation, the scheduling signaling includes downlink control information (DCI) or a radio resource control (RRC) signaling.

In a possible implementation, the downlink time unit includes a downlink slot or a downlink symbol adjacent to an uplink resource in time domain.

In a possible implementation, the base station can also transmit the time division duplex uplink and downlink configuration message to the terminal to indicate a transmission direction of each time unit, and the terminal determines the downlink time unit based on the transmission direction of each time unit.

It is also noted that the base station does not schedule uplink transmission in a downlink time unit which is not adjacent to the uplink resource in the time domain, and the base station does not cause a guard period to exist between the uplink subband and the downlink time unit (downlink slot or downlink symbol).

In this embodiment, the base station can non-explicitly configures the uplink subband for the terminal through the scheduling signaling, such that the present disclosure can effectively solve the problem that the terminal needs additional switching time from downlink reception to uplink transmission, and can avoid interference from downlink transmission to uplink transmission, reduce the negative impact of the additional guard period on the system performance, and improve the feasibility and reliability of the full-duplex (e.g., cross division duplex, xDD) communication.

In order to facilitate understanding of the foregoing methods, further examples of the uplink transmission methods provided in the present disclosure are as follows.

In an embodiment 1, for example, the terminal is a Rel-18 or later version terminal with a half duplex capability or a full duplex capability, which is not limited by the present disclosure. For example, the base station performs a full duplex operation in the downlink slot of the time division duplex (TDD) frequency band, i.e., scheduling downlink data and uplink data simultaneously. In order to facilitate understanding of the foregoing methods, further examples of the uplink transmission methods provided in the present disclosure are as follows.

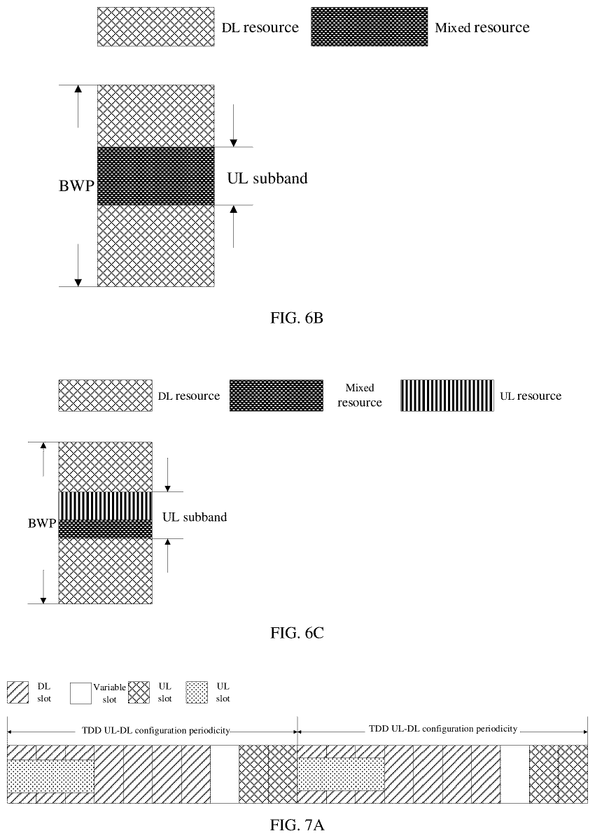

The frequency domain resources for DL transmission and UL transmission in the DL slot are independent and do not overlap with each other, as shown in FIG. 6A.

The frequency domain resources for DL transmission and UL transmission in the DL slot overlap completely, as shown in FIG. 6B.

The frequency domain resources for DL transmission and UL transmission in the DL slot partially overlap, as shown in FIG. 6C.

In this embodiment, for example, the terminal has a full duplex capability, and the base station configures the uplink subband for uplink transmission in the designated time unit through the explicit configuration signaling. When configuring the uplink subband, the base station needs to follow the following rules:

the designated time unit for configuring an uplink subband is adjacent to the uplink resource in the time domain, i.e., the designated time unit is adjacent to the uplink symbol and after the uplink symbol;

the uplink subband is located on a time unit (that may be a slot) adjacent to the uplink symbol, or the uplink subband is located on N consecutive time units (that may be slots) adjacent to the uplink symbol, where N is a positive integer greater than 1.

The uplink subband is continuous in the time domain, that is, there is no DL-to-UL switching point.

For the terminal, a configuration of the uplink subband which does not satisfy the above-mentioned conditions is not expected.

In this embodiment, a TDD UL-DL configuration configured by the base station is DDDDDDDSUU, and the terminal supports the full-duplex capability, illustrated by the example in FIG. 6A, i.e., the terminal supports the subband-based full-duplex mode.

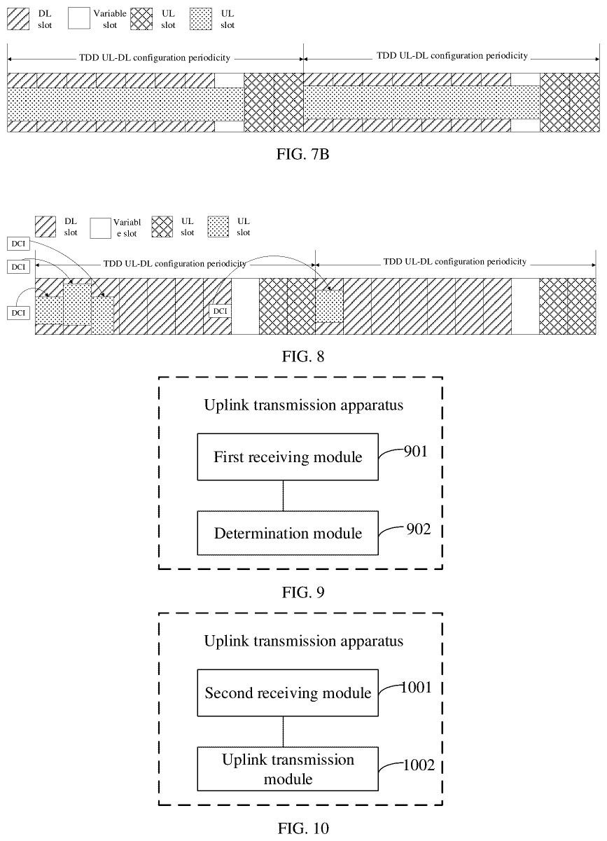

Referring to FIG. 7A, the uplink subband is located in a DL slot #0, a DL slot #1, and a DL slot #2. Alternatively, as shown in FIG. 7B, the uplink subband is located in a DL slot #0, a DL slot #1, a DL slot #2, a DL slot #3, a DL slot #4, a DL slot #5, a DL slot #6 and a flexible slot #7.

It is to be noted that the present disclosure does not limit the number of designated time unit for configuring the uplink subband. That is, under the aforementioned conditions, the upstream subband may include any number of consecutive slots in the time domain.

In an embodiment 2, for example, the terminal is a Rel-18 or later version terminal with half duplex capability or full duplex capability, which is not limited by the present disclosure. For example, the base station performs a full duplex operation in the downlink slot of the time division duplex (TDD) frequency band, i.e., scheduling downlink data and uplink data simultaneously. In order to facilitate understanding of the foregoing methods, further examples of the uplink transmission methods provided in the present disclosure are as follows.

The frequency domain resources for DL transmission and UL transmission in DL slot are independent and do not overlap with each other, as shown in FIG. 6A.

The frequency domain resources for DL transmission and UL transmission in the DL slot overlap completely, as shown in FIG. 6B.

The frequency domain resources for DL transmission and UL transmission in the DL slot partially overlap, as shown in FIG. 6C.

In this embodiment, for example, the terminal has the full duplex capability, and the base station does not explicitly configure the uplink subband, but instead indicates to the terminal the resource position for uplink transmission in the DL slot through uplink scheduling. For the uplink subband for uplink transmission, the terminal side has the following restrictions:

the terminal does not expect the base station to schedule the uplink transmission in a DL slot that is not adjacent to the uplink resource in the time domain;

The terminal does not expect a guard period between the uplink subband and the downlink time unit (DL slot/DL symbol).

Correspondingly, for the base station side, the uplink scheduling in the DL slot needs to follow the following restrictions: the base station schedules the uplink transmission in the DL slot adjacent to the uplink resource in the time domain.

In this embodiment, for example, the TDD UL-DL configuration configured by the network side is DDDDDDDSUU. For example, the terminal supports the full-duplex capability, illustrated by the example in FIG. 6A, i.e., the terminal supports the subband-based full-duplex mode. For example, the base station schedules the terminal to perform uplink transmission in the DL slot through the DCI, and the resource position of the uplink sub-band for the uplink transmission is shown in FIG. 8.

The present disclosure can effectively solve the problem that the terminal needs additional switching time from downlink reception to uplink transmission, and can avoid interference from downlink transmission to uplink transmission, reduce the negative impact of the additional guard period on the system performance, and improve the feasibility and reliability of the full-duplex (e.g., cross division duplex, xDD) communication.

Corresponding to the foregoing method embodiments, the present disclosure further provides corresponding apparatuses embodiments.

FIG. 9 is a block diagram illustrating an uplink transmission apparatus according to an embodiment of the present disclosure. As shown in FIG. 9, the uplink transmission may include a first receiving module 901 and a determination module 902.

The first receiving module 901 is configured to receive a configuration signaling, for configuring an uplink subband in a designated time unit, transmitted by a base station, where the designated time unit is a time unit which is adjacent to an uplink resource in time domain and after an uplink time unit, and of which a transmission direction is not designated as an uplink direction.

The determination module 902 is configured to determine, based on the configuration signaling, the uplink subband for uplink transmission in the designated time unit.

FIG. 10 is a block diagram illustrating an uplink transmission apparatus according to another embodiment of the present disclosure. As shown in FIG. 10, the uplink transmission apparatus may include a second receiving module 1001 and an uplink transmission module 1002.

The second receiving module 1001 is configured to receive a scheduling signaling transmitted by a base station, where the scheduling signaling is configured to schedule a resource position for uplink transmission in a downlink time unit.

The uplink transmission module 1002 is configured to perform the uplink transmission at the resource position scheduled by the scheduling signaling.

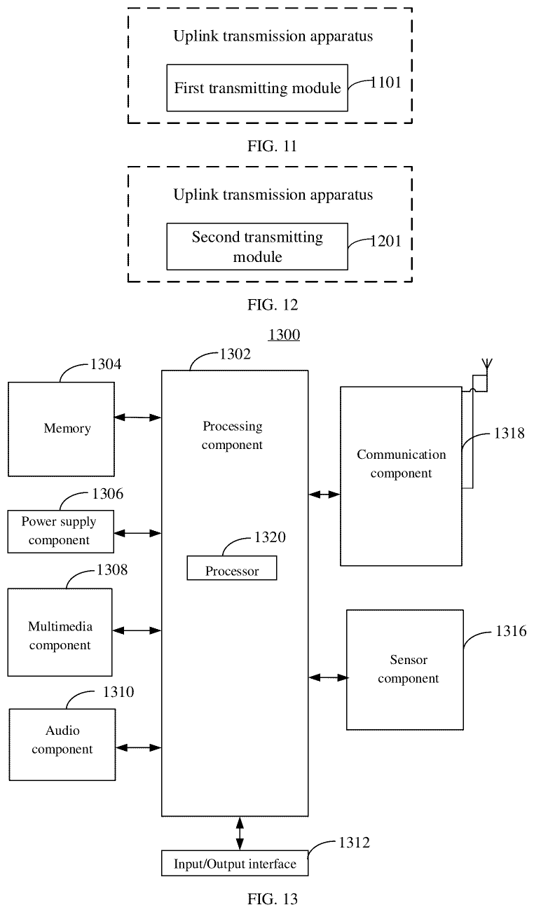

FIG. 11 is a block diagram illustrating an uplink transmission apparatus according to yet another embodiment of the present disclosure. As shown in FIG. 11, the uplink transmission apparatus may include a first transmitting module 1101.

The first transmitting module 1101 is configured to transmit a configuration signaling for configuring an uplink subband in a designated time unit to a terminal, where the designated time unit is a time unit which is adjacent to an uplink resource in time domain and after an uplink time unit, and of which a transmission direction is not designated as an uplink direction, and the uplink subband is for the terminal to perform uplink transmission.

FIG. 12 is a block diagram illustrating an uplink transmission apparatus according to still another embodiment of the present disclosure. As shown in FIG. 12, the uplink transmission apparatus may include a second transmitting module 1201.

The second transmitting module 1201 is configured to transmit a scheduling signaling to a terminal, where the scheduling signaling is configured to schedule a resource position for uplink transmission in a downlink time unit.

Since the embodiments of the apparatus substantially corresponds to the embodiments of the method, relevant parts may be referred to the description of the embodiments of the method. The apparatus examples described above are merely illustrative, where the units described as separate components may or may not be physically separated, and the components displayed as units may or may not be physical units, i.e., may be located in one place or may be distributed to multiple network units. Some or all of these modules can be selected according to actual needs to achieve the purpose of the solution of the present disclosure. It may be understood and implemented by those skilled in the art without creative work.

Correspondingly, the present disclosure provides a computer-readable storage medium, storing computer programs thereon, where the computer programs, when executed by a processor, cause the processor to perform any one of the uplink transmission methods of the terminal side.

Correspondingly, the present disclosure provides a computer-readable storage medium, storing computer programs thereon, where the computer programs, when executed by a processor, cause the processor to perform any one of the uplink transmission methods of the base station side.

Correspondingly, the present disclosure provides an uplink transmission device, and the uplink transmission device includes: a processor; and a memory storing instructions executable by the processor; where the instructions, when executed by the processor, cause the processor to perform any one of the uplink transmission methods of the terminal side.

FIG. 13 is a schematic structural diagram illustrating an electronic device 1300 (an uplink transmission device) according to an embodiment of the present disclosure. For example, the electronic device 1300 may be a mobile phone, a tablet computer, an e-book reader, a multimedia player, a wearable device, a vehicle-mounted terminal, an ipad, a smart TV or other terminal.

Referring to FIG. 13, the electronic device 1300 may include one or more of the following components: a processing component 1302, a memory 1304, a power supply component 1306, a multimedia component 1308, an audio component 1310, an input/output (I/O) interface 1312, a sensor component 1316, and a communication component 1318.

The processing component 1302 generally controls the overall operation of the electronic device 1300, such as operations associated with displays, phone calls, data communications, camera operations, and recording operations. The processing component 1302 may include one or more processors 1320 to execute instructions to complete all or a part of the steps of the foregoing uplink transmission methods. Further, the processing component 1302 may include one or more modules to facilitate interaction between the processing component 1302 and another component. For example, the processing component 1302 may include a multimedia module to facilitate the interaction between the multimedia component 1308 and the processing component 1302. For another example, the processing component 1302 may read executable instructions from the memory to perform steps in the uplink transmission methods provided in the above-mentioned embodiments.

The memory 1304 is configured to store different types of data to support operation at the electronic device 1300. Examples of such data include instructions, contact data, phonebook data, messages, pictures, videos, and so on for any application or method that operates on the electronic device 1300. The memory 1304 may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or a CD.

The power supply component 1306 provides power to different assemblies of the electronic device 1300. The power supply component 1306 may include a power source management system, one or more power sources and other assemblies associated with generating, managing and distributing power for the electronic device 1300.

The multimedia component 1308 includes a display screen that provides an output interface between the electronic device 1300 and a user. In some examples, the multimedia component 1308 may include a front camera and/or a rear camera. When the electronic device 1300 is in an operating mode, such as in a shooting mode or a video mode, the front camera and/or the rear camera may receive external multimedia data. Each of the front camera and the rear camera may be a fixed optical lens system or be of a focal length and a capability of an optical zoom.

The audio component 1310 is configured to output and/or input an audio signal. For example, the audio assembly 1310 includes a microphone (MIC). When the electronic device 1300 is in an operating mode, for example, in a call mode, a recording mode or a speech recognition mode, the microphone is configured to receive an external audio signal. The received audio signal may be further stored in the memory 1304 or sent via the communication component 1318. In some embodiments, the audio component 1310 also includes a speaker for outputting an audio signal.

The I/O interface 1312 may provide an interface between the processing component 1302 and peripheral interface modules. The above peripheral interface modules may include a keyboard, a click wheel, buttons and so on. Such buttons may include but not limited to: a home button, a volume button, a start button and a lock button.

The sensor component 1316 includes one or more sensors for evaluating states of the electronic device 1300 in different aspects. For example, the sensor component 1316 may detect the on/off status of the electronic device 1300, and relative positioning of component, for example, the component is a display and a keypad of the electronic device 1300. The sensor component 1316 may also detect a change in position of the electronic device 1300 or a component of the electronic device 1300, a presence or absence of the contact between a user and the electronic device 1300, an orientation or an acceleration/deceleration of the electronic device 1300, and a change in temperature of the electronic device 1300. The sensor component 1316 may include a proximity sensor configured to detect presence of a nearby object without any physical contact. The sensor component 1316 may also include an optical sensor, such as a CMOS or CCD image sensor used in an imaging application. In some embodiments, the sensor component 1316 may also include an acceleration sensor, a gyroscope sensor, a magnetic sensor, a pressure sensor, or a temperature sensor.

The communication component 1318 is configured to facilitate wired or wireless communication between the electronic device 1300 and other devices. The electronic device 1300 may access a wireless network based on a communication standard, such as Wi-Fi, 2G, 3G, 4G or 5G, or a combination thereof. In some embodiments, the communication component 1318 may receive a broadcast signal or broadcast-related information from an external broadcast management system via a broadcast channel. In an example, the communication component 1318 may also include a near field communication (NFC) module to facilitate short-range communications. For example, the NFC module may be implemented based on a radio frequency identification (RFID) technology, an infrared data association (IrDA) technology, an ultra wide band (UWB) technology, a bluetooth (BT) technology and other technologies.

In some illustrative embodiments, the electronic device 1300 may be implemented by one or more of an application-specific integrated circuit (ASIC), a digital signal processor (DSP), a digital signal processing device (DSPD), programmable logical device (PLD), field programmable gate array (FPGA), a controller, microcontroller, a microprocessor or other electronic components to execute the foregoing uplink transmission methods.

In an example embodiment, there is also provided a non-transitory machine readable storage medium including instructions, such as a memory 1304 including instructions, where the instructions are executable by the processor 1320 of the electronic device 1300 to implement the foregoing uplink transmission methods. For example, the non-transitory computer readable storage medium may be a read-only memory (ROM), a random access memory (RAM), a CD-ROM, a magnetic tape, a floppy disk and an optical data storage device, etc.

Correspondingly, the present disclosure provides an uplink transmission device, and the uplink transmission device includes: a processor; and a memory storing instructions executable by the processor; where the instructions, when executed by the processor, cause the processor to perform any one of the uplink transmission methods of the base station side.

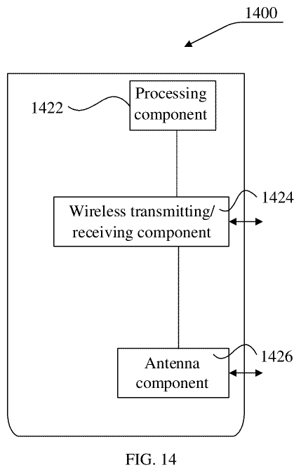

As illustrated in FIG. 14, FIG. 14 is a schematic structural diagram illustrating an uplink transmission device 1400 according to another embodiment of the present disclosure. The device 1400 may be provided as a base station. Referring to FIG. 14, the device 1400 includes a processing component 1422, a wireless transmitting/receiving component 1424, an antenna component 1426, and a signal processing portion specific to a wireless interface. The processing component 1422 may further include one or more processors.

One of the processors in the processing component 1422 may be configured to execute any one of the foregoing uplink transmission methods.

The technical solutions provided by example embodiments of the present disclosure may include the following beneficial effects.

The present disclosure can effectively solve the problem that the terminal needs additional switching time from downlink reception to uplink transmission, and can avoid interference from downlink transmission to uplink transmission, reduce the negative impact of the additional guard period on the system performance, and improve the feasibility and reliability of the full-duplex (e.g., cross division duplex, xDD) communication.

After considering the specification and practicing the present disclosure, those skilled in the art would easily conceive of other implementations of the present disclosure. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the disclosure is to be limited only by the appended claims.

1. An uplink transmission method, performed by a terminal, and comprising:
receiving a configuration signaling, for configuring an uplink subband in a designated time unit, transmitted by a base station, wherein the designated time unit is adjacent to an uplink resource in time domain and after an uplink time unit, and a transmission direction of the designated time unit is not designated as an uplink direction; and
determining, based on the configuration signaling, the uplink subband for uplink transmission in the designated time unit.

2. The method of claim 1, wherein the uplink time unit is an uplink symbol, and the designated time unit comprises a slot or a plurality of consecutive slots that are adjacent to the uplink resource in the time domain and after the uplink symbol.

3. The method of claim 2, wherein the designated time unit comprises a downlink slot, or a downlink symbol and a slot for a variable symbol, wherein the variable symbol is a symbol with a variable transmission direction.

4. The method of claim 1, further comprising:
determining, based on a time division duplex uplink and downlink configuration message transmitted by the base station, a transmission direction of each time unit.

5. The method of claim 1, wherein the uplink subband is continuous in the time domain.

6. An uplink transmission method, performed by a terminal, and comprising:
receiving a scheduling signaling transmitted by a base station, wherein the scheduling signaling is configured to schedule a resource position for uplink transmission in a downlink time unit; and
performing the uplink transmission at the resource position scheduled by the scheduling signaling.

7. The method of claim 6, wherein the scheduling signaling comprises downlink control information (DCI) or a radio resource control (RRC) signaling.

8. The method of claim 6, wherein the downlink time unit comprises a downlink slot or a downlink symbol adjacent to an uplink resource in time domain.

9. The method of claim 6, further comprising:
determining, based on a time division duplex uplink and downlink configuration message transmitted by the base station, a transmission direction of each time unit.

10. An uplink transmission method, performed by a base station, and comprising:
transmitting a configuration signaling for configuring an uplink subband in a designated time unit to a terminal, wherein the designated time unit is adjacent to an uplink resource in time domain and after an uplink time unit, and a transmission direction of the designated time unit is not designated as an uplink direction, and the uplink subband is for the terminal to perform uplink transmission; or
transmitting a scheduling signaling to a terminal, wherein the scheduling signaling is configured to schedule a resource position for uplink transmission in a downlink time unit.

11. The method of claim 10, wherein the uplink time unit is an uplink symbol, and the designated time unit comprises a slot or a plurality of consecutive slots that are adjacent to the uplink resource in the time domain and after the uplink symbol.

12. The method of claim 11, wherein the designated time unit comprises a downlink slot, or a downlink symbol and a slot for a variable symbol, wherein the variable symbol is a symbol with a variable transmission direction.

13. The method of claim 10, further comprising:
transmitting a time division duplex uplink and downlink configuration message to the terminal, wherein the time division duplex uplink and downlink configuration message is for the terminal to determine a transmission direction of each time unit.

14. The method of claim 10, wherein the uplink subband is continuous in the time domain.

15. (canceled)

16. The method of claim 10, wherein the scheduling signaling comprises downlink control information (DCI) or a radio resource control (RRC) signaling.

17. The method of claim 10, wherein the downlink time unit comprises a downlink slot or a downlink symbol adjacent to an uplink resource in time domain.

18-22. (canceled)

23. A non-transitory computer-readable storage medium, storing computer programs thereon, wherein the computer programs, when executed by a processor, cause the processor to perform the uplink transmission method of claim 1.

24. A non-transitory computer-readable storage medium, storing computer programs thereon, wherein the computer programs, when executed by a processor, cause the processor to perform the uplink transmission method of claim 10.

25. An uplink transmission device, comprising:
a processor; and
a memory storing instructions executable by the processor;
wherein the instructions, when executed by the processor, cause the processor to perform the uplink transmission method of claim 1.

26. An uplink transmission device, comprising:
a processor; and
a memory storing instructions executable by the processor;
wherein the instructions, when executed by the processor, cause the processor to perform the uplink transmission method of claim 10.
